(19) United States
(12) Patent Application Publication
(10) Pub. No.: US 2018/0092722 A1
(43) Pub. Date: Apr. 5, 2018

(54) DENTAL FLOSSING DEVICE AND PACKAGING THEREOF

(71) Applicant: Haitham Abdelmajid ALZUREIGI, Amman (JO)

(72) Inventor: Haitham Abdelmajid ALZUREIGI, Amman (JO)

(21) Appl. No.: 15/283,746

(22) Filed: Oct. 3, 2016

(51) Int. Cl. A61C 15/04

(52) U.S. Cl. CPC A61C 15/041; A61C 15/043

(57) ABSTRACT

The invention discloses a dental floss device composed of nylon-like material which confers many characteristics so far missing from currently existing dental floss systems. The invention also discloses a dental floss system which provides for an improved cleaning mechanism which takes full advantage of the material disclosed herein.

### BACKGROUND

### Field of the Invention

The current invention relates to an oral hygiene aid, and more specifically to the cleaning of the area between the teeth and the gums whereby the cleaning aid removes all the remains and leftovers lodged between the teeth and the gums. More specifically, the invention relates to extensible and pliable elastomeric floss and disposable floss dispenser units. The floss is an extensible, flexible and pliable cleaning and polishing dental floss/tape that can be used to remove plaque and discolorations between teeth, which is practical and is gentle to soft tissues including gingival tissue.

### SUMMARY

Various oral hygiene aids currently exist for interdental cleaning, including toothbrushes, dental sticks or toothpicks and dental floss/tape. Dental floss/tape is preferably used in small/narrow interdental spaces with large gingival pockets where brushes, and even dental sticks, are difficult to use due to lack of space or accessibility.

The use of dental floss is desirable for a wide variety of reasons. For a person's general health and well-being, it is a means of cleaning between the teeth and under gum margins so that bacterial or dental plaque is removed. This plaque is considered the leading cause of periodontal disease and tooth loss in adults. Flossing is also well suited for removing food particles after eating as trapped food particles can be unsightly, are often annoying, may interfere with proper speech, can cause bad breath if left over a period of time and can cause damage to both the gum and the teeth if lodged for long periods of time.

Improvements on dental floss have been described and disclosed on many prior occasions as it was noted that dental floss had several shortcomings. As an example, dental floss may cause tear and bleeding of the gum as a result of the hardness of the material which composes the floss.

Other shortcomings of current dental floss devices include the inability of said products to access all the small openings between the teeth and the reason is that the plastic material which is a strong material does not expand and its thickness cannot be controlled, so that it cannot penetrate between very narrow teeth openings. In the case where the plastic thread is forced between the narrow teeth as a result of pressure on the string that leads to a strong push of thread toward the gums causing wounds.

In addition, the current products cannot remove lurking material between the teeth and gums because previous products occupy a narrow and small space between the teeth and gums. Therefore, only removing the suspended matter of the size of the product only. It is ideal to have a product which starts off thin enough to be able to pass between the tooth-tooth junction, yet be foldable and bendable to several layers to be able to cover a larger space to increase cleaning efficiency.

The prior art primarily discloses innovations on the material used for manufacturing the floss to improve its physical properties such as its strength as is the case of U.S. Pat. No. 6,539,951 and U.S. Pat. No. 7,060,354; or controlling certain physical characteristics such as its length and tensility.

Others introduce the concept of a dental tape in lieu of the usual floss string in an attempt to provide certain benefits as disclosed by U.S. Pat. No. 8,408,219.

The current invention has means to address the defects of the existing dental floss systems in the ability of the floss of the current invention to penetrate between the teeth, be characterized by its softness on the enamel and gums and the ability to remove all forms and size of remains lodged between the teeth and between the teeth and gum.

### BRIEF DESCRIPTION OF THE DRAWINGS

FIG. 1 shows an embodiment of the invention on the ease of sliding the floss of the invention between the tightest bound teeth (1) and being able to control the width of said floss as the movement slides it between said teeth and between teeth and gum (3).

FIG. 2 shows one embodiment of a floss strip of a pre-determined width (3) and length (4) and the ability to controllably fold the said floss strip along its longitudinal side (2).

FIGS. 3, 4, and 5 are representations of various possible packaging for conveniently and optimally storing and dispensing the dental floss tape.

### DETAILED DESCRIPTION

The current invention introduces a new technology which contributes to oral care in a way which does not currently do so. Combining the use of flexible and transparent nylon plastic stored in cardboard or plastic dispenser boxes creates a new idea in the world of oral care. The use of flexible and transparent nylon plastic prevents the wounding of the gum as a result of its soft edges and bendable characteristics, which help to maintain healthy gums. The new technology is also easy to control in terms of tensile strength and elongation as compared to other currently existing teeth cleaning products; and the high flexibility of the extension of the product and the ability to fold it and bend it helps its users to remove the maximum amount of residue between the teeth and gums. In addition, the material used in this invention allows reducing the thickness of the dental floss tape upon pulling at the ends, and one said pulling is stopped, the ability of the dental floss tape to resume its semi original thickness.

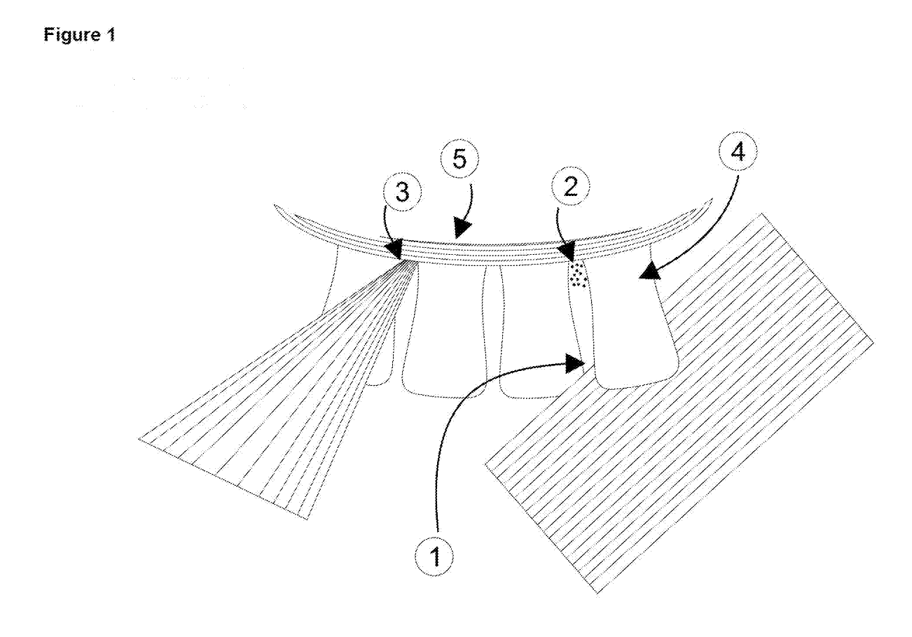

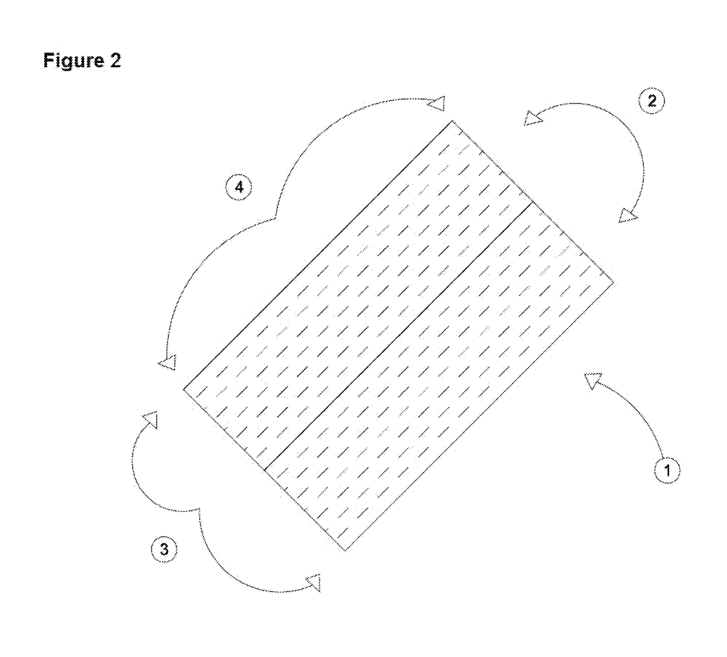

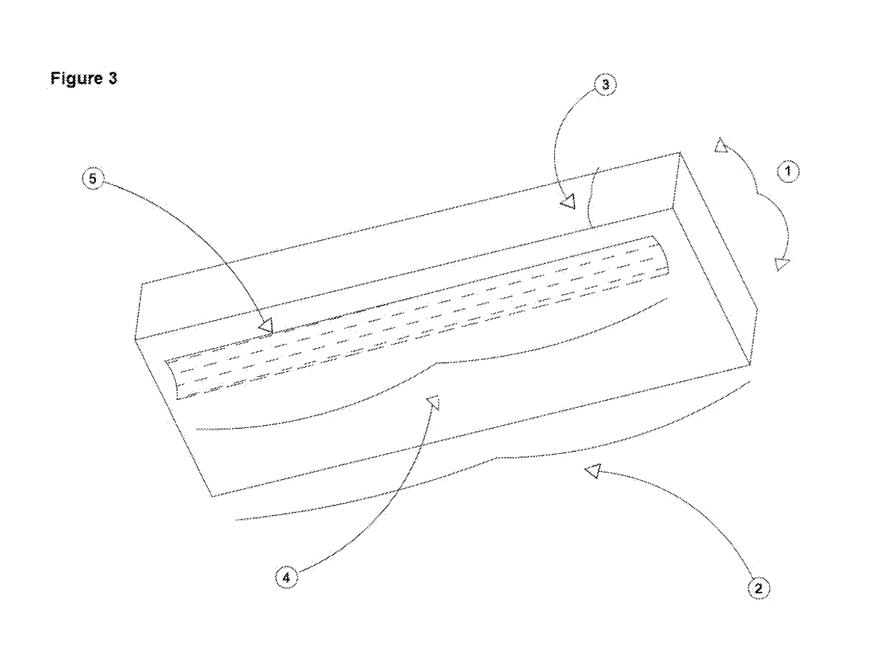

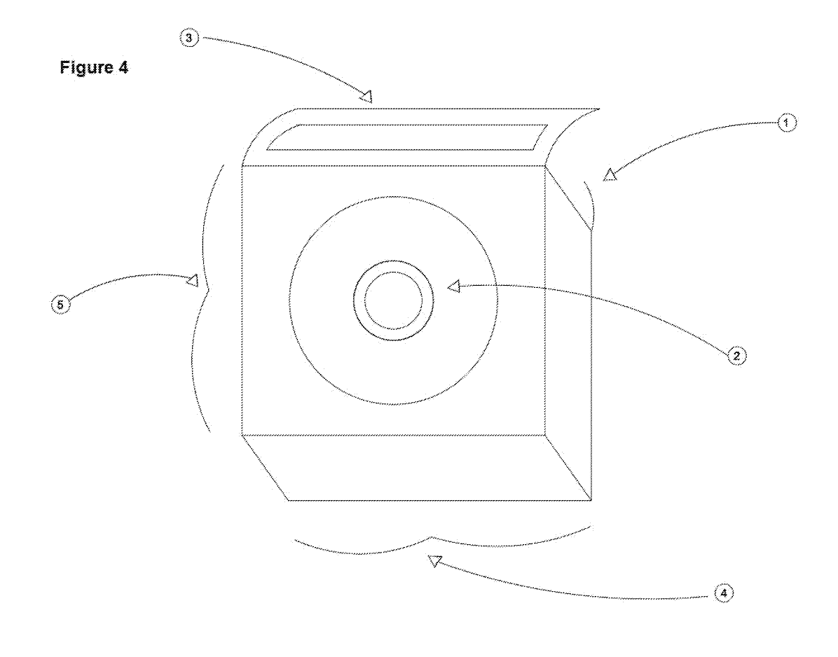

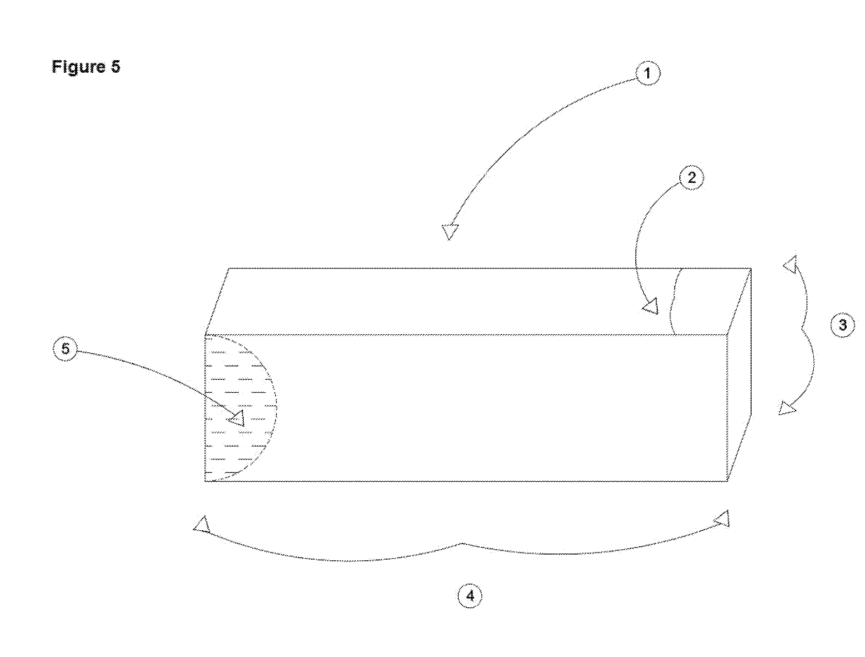

In an embodiment of the current invention, the material used has nylon-like properties. As nylon-like material is a flexible material whose thickness can be controlled through stretching when the two ends, enabling it to slide effortlessly between very tightly close teeth as shown in FIG. 1 (1). In one embodiment the nylon-like material is Low Density Polyethylene Resin (LDPR). The product of this embodiment allows for cleaning various size areas more efficiently by expanding for instance as in FIG. 1 (2) whereby more cleaning is effected by folding the dental floss tape for instance as in FIG. 1 (3). The material of the embodiment is also soft and gentle and does not cause tear or bleeding of the gum shown in FIG. 1 (5) even when reaching into tighter spaces between the teeth and the gum because its foldable and easily bendable as shown in FIG. 1 (3).

The advantages of a material such as the one cited in the one embodiment above is that it has a high tensile strength at break of at least 20.0 MPa and preferably about 24.0 MPa. Such a property is highly advantageous as a material for the current invention as it allows for decreasing the thickness of the floss by stretching without the risk of breaking thus improving its ability to penetrate between very tightly bound teeth. In addition, such a property allows for improved control of the manipulation of the size of the floss by maximizing the space occupied between teeth and gum in order to increase the efficiency of the removal of matter lodged between the teeth and between the teeth and gums. Lastly, such a property increases the size of the piece being used during flossing due to its highly expandable characteristics when stretching the two ends that leads to length enlargement which in turn decreases the consumption of said floss device.

A material such the one cited in the one embodiment above also benefits from the ability to control its thickness. This characteristic, of being able to increase the thickness, reduces the risk of wounding the gums contrary to what has been the case in many of the current teeth cleaning products, but at the same time, the thickness can be reduced down to a degree where it can be slid tightly into narrow teeth easily. The reduced thickness can be reversed to its semi-original thickness again when users stop pulling both ends. As a result, the property turns to soft bendable thick characteristic that does not damage the gum.

Furthermore, a material such as the one cited in the one embodiment above benefits from an elongation at break value of at least 350% and preferably 370%. This material's ability to be elongated without being interrupted is very high, contributing to double its size and thus reduce the amount of material consumption in the process of cleaning teeth. The high-capacity in the elongation contributes to the ability to access very easily between tight teeth without causing injuries. The elongation feature helps users in easy control in the folds and bends inside the jaw, which helps in the process of cleaning the teeth.

A material such as the one cited in the one embodiment above is characterized by a cross-sectional length of varying sizes and in one embodiment of up to 1.75 cm. This characteristic of a floss device, in addition to its ability to fold easily into several layers, helps in the removal of a larger part of the matter lodged between the teeth and that is due to the cross-sectional size of the product of the current invention and its increased volume.

Lastly, a material such as the one cited in the one embodiment above is characterized by having high flexibility and softness. This characteristic helps its users to turn and bend the product during the cleaning inside the teeth as needed, leading to increase in cleaning size and coverage space between the teeth and gums which contributes to remove as much of the unwanted remains.

The production of nylon as transparent flexible and soft plastic in laboratories and factories is of the utmost ease. It can be cut into different shapes to suit taste and convenience for eventual use. This allows for multiple packaging and presentation shapes and forms. While preparing the dental floss device itself is of the utmost importance, it is necessary to have a device made of a material that is amenable to various presentations, such as size, bending, wrapping, etc. to cater to the various needs of industrial production and ease of use.

The presentation of the dental floss product for ease of use and convenience is easy given the material with which the product is made. The characteristics of the material allow it to be packaged under several forms. In one embodiment, the dental floss can be manufactured to be in rectangular pieces of about 3.5 cm in width and 7.0 cm in length and bent in half longitudinally and packaged in rectangular shaped packages designed for allowing the user to pull out one piece of floss at a time.

In another embodiment, and again given the material of the dental floss, it is possible to prepare a roll of the floss where as an example the total length is 20 m whereas the width is 1.75 cm (folded width of 3.5 cm) and packaged in a box where the user can unroll a pre-determine length of floss.

While particular embodiments of the invention have been cited and described herein, the present invention is not limited to those. It should be apparent that changes and modifications may be incorporated and embodied as part of the present invention within the scope of the following claims.

1. Dental floss tape which can be elongated and stretched before and after insertion in the space between the teeth wherein said dental floss tape can
a. Pass between narrowly tight teeth; and
b. Increase and decrease in size to maximize the cleaning efficiency.

2. The dental floss tape of claim 1 wherein said tape is composed of flexible, transparent plastic.

3. The dental floss tape of claim 2 wherein said transparent plastic is bendable and easily foldable.

4. The dental floss tape of claim 3 wherein said tape does not cause tear or bleeding of the gum.

5. The dental floss tape of claim 2 wherein the plastic is a nylon fiber.

6. The dental floss tape of claim 5 wherein the thickness of said fiber is reduced when pulled at its ends, and assumes its semi original thickness when the pulling at said ends is stopped.

7. The dental floss tape of claim 3 wherein said nylon fiber has an elevated tensile strength at break.

8. The dental floss tape of claim 5 wherein said tensile strength at break is at least 20 MPa.

9. The dental floss tape of claim 3 wherein said nylon fiber has an elevated elongation at break.

10. The dental floss tape of claim 7 wherein said elongation at break is at least 350%.

11. A packaging for storing and dispensing dental floss tape.

12. The packaging of claim 9 wherein the dental floss tape is stored as strips.

13. The packaging of claim 9 wherein the dental floss is rolled around a reel.
